(19) United States
(12) Patent Application Publication
(10) Pub. No.: US 2005/0177446 A1
(43) Pub. Date: Aug. 11, 2005

(54) Method and system for supporting coordination and collaboration of multiple shoppers

(75) Inventor: Robert S. Hoblit, Knightdale, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/776,492

(22) Filed: Feb. 11, 2004

(51) Int. Cl. G06F 17/60

(52) U.S. Cl. 705/26

(57) ABSTRACT

System and method for supporting coordination and collaboration of multiple users, such as shoppers, in an activity. Individual lists are organized, each list associated with a different participating user and including multiple entries promoting efficiency in the activity, each entry describing an item to be located and/or obtained by the user. Each list is accessible on an electronic device by each user, where a user can obtain or locate the items described on that user's list during the activity. In another aspect, users can communicate messages and list changes and locate other users during the activity.

### FIELD OF THE INVENTION

The present invention relates to communication and coordination methods and devices, and more particularly to a method and system for improving the ability of multiple shoppers or other users to collaborate and coordinate shopping activities or similar activities.

### BACKGROUND OF THE INVENTION

One routine task that consumers engage in is shopping at retail stores, such as grocery stores, hardware stores, etc. A typical problem associated with shopping is locating the items that are of interest. For example, shoppers in a grocery store must locate the items on their shopping lists, then take their items to the checkout for purchase. Difficulties in locating items are compounded by unfamiliar stores, by changes in the store layout, and by retailer's desire to keep the shopper in the store in order to market additional products. The retailer's attempts to keep the shopper in the store are often in direct opposition to the shopper's desire to complete their task as quickly as possible. This is particularly true of grocery shopping. Although shoppers typically try to obtain the desired items in the most efficient manner, a shopper typically does not organize a shopping list based upon the items' locations in the store. A shopper may thus forget one or more items, causing the shopper to backtrack for the forgotten items. As a result, the shopper's trip to the store is prolonged.

Certain conventional systems do exist for improving the ability of a shopper to locate items of interest. These conventional systems allow a user to input items of interest, typically using a portable personal digital assistant (PDA), scanner or other input/output (I/O) device such as a keyboard. The conventional system then provides the shopper with aids in locating at least some of the items entered. For example, conventional systems provide the shopper with locations of items within a store or directions to individual items within the store. Other conventional systems provide a map, including the route a shopper should take. In addition, some conventional systems for aiding shoppers suggest alternative and/or additional products. Some systems are stationary kiosks at the store or internet-based, where the aids are printed out so that the shopper can use the aids while shopping. Other systems may include small devices residing on shopping carts which typically include a display to provide the user with information.

The existing shopping assist systems may provide additional convenience to shoppers; however, these shopping assist systems may be not be flexible enough to adapt to certain shoppers' needs. For example, due to time constraints, some shoppers try to spend a minimum amount of time shopping. One way to greatly save time while shopping is to divide the shopping tasks among two or more people, each shopper having particular items that he or she will find in the store and obtain for purchase. The shoppers may join each other again prior to paying for the items to combine their obtained items into one group. None of the existing shopping assist systems can help such multiple shoppers collaborate and coordinate their shopping tasks.

Accordingly, what is needed is a system and method for aiding collaborative shoppers in locating desired items and planning/coordinating their shopping tasks. The present invention addresses such a need.

### SUMMARY OF THE INVENTION

The invention of the present application provides a system and method for supporting coordination and collaboration of multiple shoppers or other users in an activity. In one aspect of the invention, a method for coordinating the activity of participating users, such as shoppers, includes organizing individual lists, each individual list being associated with a different participating user and including multiple entries, each entry describing an item to be obtained or located by the associated user during the activity. Each individual list is provided to a different electronic device, where each electronic device is accessible to a different participating user, and where each participating user can access the associated individual list and obtain or locate the items described on that user's individual list during the activity. Different aspects provide a computer readable medium and a system with similar features.

In a second aspect of the invention, a method for coordinating the activity of a plurality of participating users, such as shoppers, includes receiving an individual list on an electronic device accessible by a participating user, the individual list including at least one entry, each entry describing an associated item to be obtained or located by the participating user during the activity. Updates and changes are sent out to the individual list during the activity over a communication link, where at least one other electronic device accessible to another participating user can receive the sent updates and changes. Different aspects provide a computer readable medium and a system with similar features.

In a third aspect of the invention, a method for coordinating the shopping activity of a plurality of participating shoppers includes providing a plurality of portable electronic devices, each electronic device accessible to a different one of the participating shoppers, and facilitating the shopping activity of the participating shoppers in a shopping area via the electronic devices by allowing communication between participating shoppers and allowing each shopper to locate at least one other shopper in the shopping area during the shopping activity.

The present invention provides methods and systems for coordinating the shopping or similar activity of two or more users. Furthermore, the present invention allows the users to collaborate during the activity. These features allow multiple shoppers to efficiently locate and obtain desired items in a store or other location without redundancy and with a minimum of time and effort expended.

### BRIEF DESCRIPTION OF THE DRAWINGS

FIG. 1 is a flow diagram illustrating a method of the present invention for supporting coordination and collaboration of multiple shoppers in a shopping activity;

FIG. 2 is a flow diagram illustrating an example of the step of FIG. 1 for generating multiple optimized individual lists from a master list; and

FIGS. 3a and 3b are block diagrams of electronic devices suitable for use in the present invention.

### DETAILED DESCRIPTION

The present invention relates to communication and coordination methods and devices, and more particularly to a method and system for improving the ability of multiple shoppers or other users to collaborate and coordinate shopping activities or similar activities. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of a particular systems and products provided in a particular manner, i.e., shopping for items in one or more retail stores. However, one of ordinary skill in the art will readily recognize that this method and system will operate effectively for other systems, other products and other activities/locations, such as inventory collaboration in warehouses, etc. The present invention will also be described in the context of particular methods having certain steps. However, the method and system operate effectively for other methods having different and/or additional steps not inconsistent with the present invention.

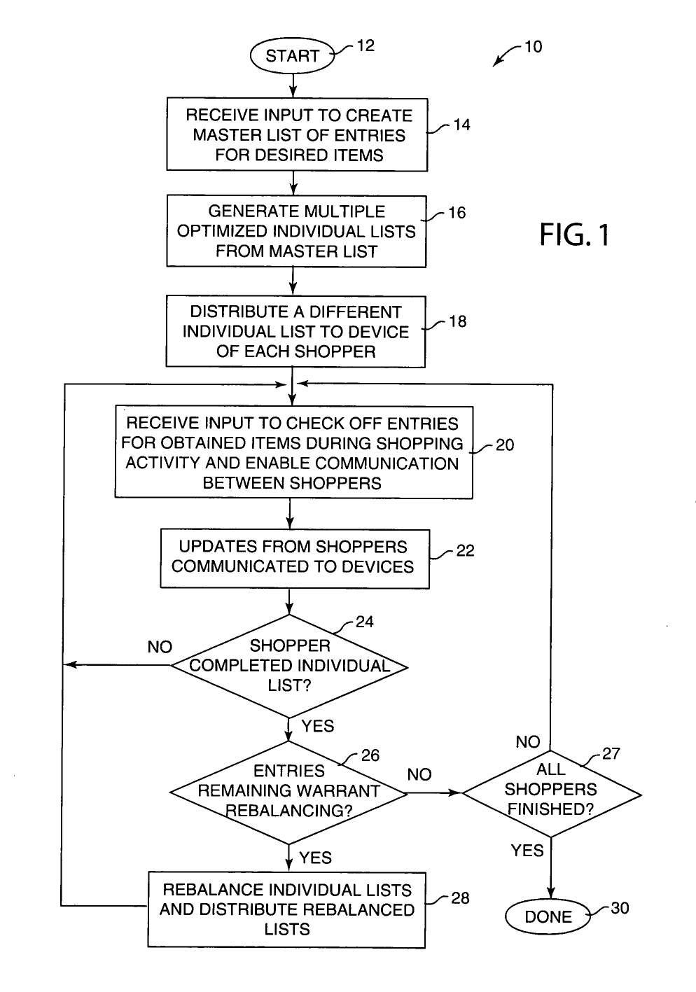

FIG. 1 is a flow diagram illustrating a method 10 in accordance with the present invention for improving the ability of multiple shoppers (or other users) to collaborate and coordinate their activities. The multiple shoppers preferably intend to collaborate and coordinate their actions so that each shopper can locate and obtain different items at the same time, so as to minimize the time needed for the entire shopping activity.

In a preferred embodiment, each participating shopper has access to an electronic device, e.g., computer, cell phone, organizer, etc., which may be carried by the shopper as he or she is performing the shopping activity. The device preferably implements those steps of the methods described herein which are appropriate, e.g., involving calculation, optimal routes, list rebalancing, etc. These steps are typically implemented using program instructions stored on a computer readable medium, such as memory, hard drive, optical disk (CD-ROM, DVD-ROM, etc.), magnetic disk, etc. These steps can be implemented in hardware (logic gates, etc.), software, or a combination thereof. In addition, the electronic device preferably includes an output device which a shopper can view and/or hear information pertinent to the invention, as described below.

The method begins at 12, and in step 14, one or more shoppers input entries to an electronic device, these entries each describing an item to be located and obtained during shopping activity by multiple shoppers participating in the shopping activity. The entries collectively form a master list. In a common scenario, the items are to be located and obtained for purchase from a retail store or similar location. For example, shoppers may have a shopping list describing multiple items to be purchased during a trip to the grocery store, and this shopping list would be input in step 14.

The electronic device into which the list is entered can be implemented as any of several different types of devices. For example, the device can be a portable computer or portable device/article that includes a computer, such as a laptop computer, personal digital assistant (PDA), cell phone, tablet computer, portable organizer, electronic wristwatch, a device attached to or included in a shopping cart, etc. Such a portable device can store the master list and any other pertinent data and program instructions in its own memory. Alternatively, the electronic device can be a portable device that is linked to a larger computer system, e.g. server or desktop computer, which communicates with a number of such portable electronic devices over communication links, such as wireless links.

A shopper can input the master list to the electronic device in a number of ways according to various embodiments. For example, the shopper can select the entries of the master list from displayed menus using a pointing input device such as a stylus, wheel, trackball, or mouse, input text entries using buttons or keys on the electronic device, or input entries by voice using a microphone on the electronic device. In some embodiments, shoppers can utilize a Smart Card or other storage card or device, which stores master list data which the electronic device can access. A bar code scanner could be used to scan bar codes of desired items to input entries describing those items. The shopper can use a keyboard, touch screen or other device to input the items. From a remote location, a shopper can upload the items to the electronic device via the Internet or other network using a computer system. In one embodiment, the entries entered in step 14 describe unique items, for example by bar code or product name, such as particular brand and style of peanut butter. However, in other embodiments, the entries can describe more general categories of products. For example, entries could be “soap,” “peanut butter,” or a particular brand of peanut butter.

In some embodiments, step 14 also includes inputting additional information to the electronic device by the shopper. For example, the additional information can specify one or more stores at which the shoppers wish to shop (the name of the store, address or location, etc.). In some embodiments, a particular store can be selected by the shopper, and then a list of entries describing available items at that store can then be presented to the shoppers, where the shoppers can then select the entries describing items they want to be on their master list. Preferably, an electronic device in such an embodiment can be easily updated with data from the store or an information source, where the data describes the current item inventory of stores selectable by the user. The data updates can be made to the electronic device, for example, using a wide-area network, wireless network, the Internet, distributed storage media (CD-ROMs), etc. Some embodiments can allow the electronic device to receive information from the store(s) so that entries made on the master list can be immediately compared to current store inventory.

In the embodiments allowing a store's inventory to be checked, a database of store items can be accessed, e.g. a database provided by a retailer. The database can include at least items corresponding to entries that can be entered on shoppers' lists and (in some embodiments) the corresponding locations of the items in the store. The database may be organized by uniquely identifiable items, such as a particular brand of peanut butter, by categories of items, such as peanut butter, or in another manner. The entries on the master list can be compared to the items in the database to find matches. All of the items described by the master list may not be obtainable from a store. For example, some entries may not have a match because the retailer might not carry a particular item or the item may be sold out. In such a case, a message can be output to the users indicating the items are not available, and alternatives or substitutes suggested, or a store location can be suggested that may have the item or all the desired items.

Some embodiments can allow a master list of items to be automatically generated for particular shopper(s), based on a known history of the shopper(s). For example, if the shoppers gets approximately the same items on every shopping trip to a particular store, those items can be automatically presented to the shopper(s) in a master list once the shopper inputs the desired store at which to shop. The generated master list can be quickly edited by the shoppers if any changes specific to this particular shopping activity need to be made, e.g. input additional items, remove some items, etc.

Although a single master list is generally referred to herein, other embodiments can employ multiple master lists, e.g., when the shoppers wish to shop at multiple stores during one trip, a master list can be provided per store.

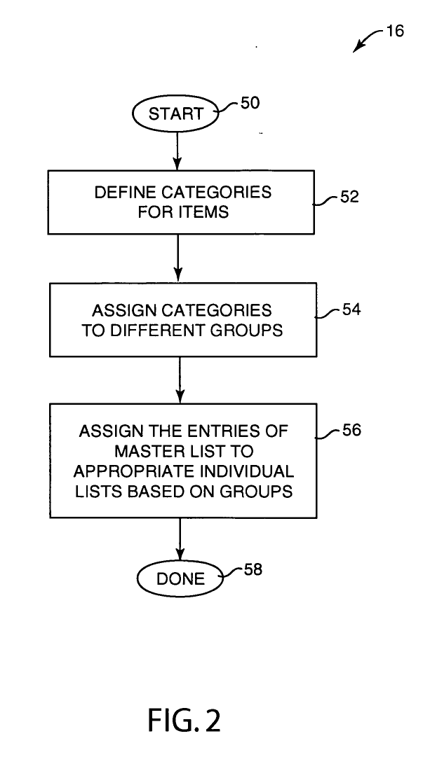

In step 16, multiple optimized “individual lists” are generated from the master list, preferably one individual list for each shopper that will be engaged in the collaborative shopping activity (or other similar activity). The entries on the master list are divided amongst the individual lists preferably to allow a balanced and efficient shopping activity to be achieved by the participating shoppers, e.g. to achieve an approximately equal shopping time for each shopper. Thus, entries on each individual list preferably will not appear on any other individual lists so that the shoppers do not duplicate each others' activities. Any number of characteristics of the items are preferably used in the generation of the individual lists, such as the category or categories which each item falls under and the number of items desired. Other characteristics and data may also be used, such as the layout of the store where the shopping is to take place, the location of the items within the store, etc. One example of the generation of the optimized individual lists is described below with reference to FIG. 2. The individual optimized lists can be generated by a computer system or device which received the master list of step 14, or by another device which receives the master list data from one or more other devices.

In step 18, a different optimized list is distributed to the electronic device of each participating shopper. The device possessed by each shopper is preferably linked to the device or computer system that has generated the individual lists so that the individual lists can be quickly transmitted to all participating shoppers. Furthermore, the electronic devices are all linked to each other to allow communication of information between shoppers, as described below. Different embodiments of network topologies can be implemented to link the electronic devices; for example, each device can be linked to each other in peer-to-peer configuration, or each device can be linked to a server in a client-server model. Each electronic device preferably can wirelessly receive the data making up the individual list for the associated shopper.

In some embodiments, in addition to an individual list of items, in step 18 each participating shopper's electronic device can also receive (or generate locally, once the individual list is received) an optimized route through the store to obtain the items corresponding to entries on the individual list in an efficient manner. The route can be specified in the form of text directions, a graphical map or, in embodiments using a robotic shopping cart, driving the robotic cart to the locations on the route. Robotic shopping carts are described in greater detail in copending patent application Ser. No. 10/426,082, filed Apr. 29, 2003, and incorporated herein by reference in its entirety. In some embodiments, multiple different efficient routes can be determined and presented to the user, thereby allowing the user to select a desired route from the presented routes.

In step 20, input is received at the electronic devices from the participating shoppers as they perform their shopping activity to check off entries on their individual lists (and/or master list) as the items are obtained, and communication between shoppers is enabled as necessary. Thus, this step is performed at the shopping location; the previous steps can be performed at other locations or at the shopping location, as desired.

Preferably, each shopper goes to various locations in the store to locate and obtain the items corresponding to the entries on his or her individual list. Some embodiments can provide a map of the store locations where the desired items are located, and/or provide other information to the shoppers to assist in locating items, such as an optimized route through the store to get the items in an efficient manner. Once a shopper has located an item and obtained it (e.g., taken it off the shelf for purchase, or otherwise designated it for purchase), then the shopper can “check off” the corresponding entry from his or her individualized list, i.e., select or designate the corresponding entry to indicate that the associated item has been or is being obtained. For example, using a display or touchscreen, the shopper can select a box or icon that designates an item as having been obtained, or select the entry itself which will then have a check mark displayed next to it, put a line through the entry, or remove the entry from the displayed list.

In addition, in some embodiments a shopper is able to make changes to the master list, such as checking off entries on the master list that correspond to obtained items. For example, if a first shopper happens to locate an item that is not on the first shopper's individual list, but is on the master list and on a second shopper's list, the first shopper can still obtain the item and check it off by accessing the master list through his or her device and inputting the check off designation.

Furthermore, in some embodiments a shopper can add one or more entries to his or her individual list which describe items not currently on that list or the master list, and check off the added entries when the corresponding items are located and obtained. This can be useful when it is discovered that a remembered item was originally mistakenly omitted from the master list. Each added entry can optionally have a “distributable” characteristic, which can be toggled by the shopper. If the shopper designates an added entry as distributable, the added entry data is provided to all the electronic devices of the other shoppers (or just some of the other shoppers' electronic devices, as indicated by the user). If the shopper designates an added entry as not distributable, the added entry is only known to that shopper and is not communicated to the other electronic devices. This option allows an item to be located and obtained without the knowledge of the other shoppers, e.g. a surprise gift.

In addition, in some embodiments any shopper is able to add entries to the master list during the shopping activity. The added entries can then be immediately placed on appropriate individual list(s), e.g., using the same optimization method used in step 16. The location(s) of added entries in the store can be determined immediately and any optimized route through the store can be updated to include the added entries. Rebalancing of entries to different individual lists can also occur due to the addition of entries; rebalancing is described in greater detail with respect to steps 26 and 28. In some embodiments, the shopper can edit his or her individual list at any time and multiple times while shopping. Some embodiments may allow one or more other shoppers to change a different shopper's individual list via the communication link, e.g. with the assent of the particular shopper whose list is to be changed, or without such assent, depending on selected preferences.

During step 20, a shopper can also communicate with the other shopper(s), as necessary or desired. For example, if each shopper's electronic device has cell phone capability or other direct communication ability, then the shopper can call one or more other shoppers during the shopping activity. Alternatively, voice-based communication can be provided using a computer network by digitizing voice data and sending it to other devices using a standard network protocol, such as Internet Protocol (IP). In some embodiments, text-based communication can be used, where a shopper inputs text via keyboard, pen input, or other interface. Such communication is sometimes needed when one shopper is unsure of which item to obtain and would like to consult with one or more other shoppers, e.g., what particular brand or style of peanut butter to get. Lack of such communication leads to various inefficiencies; for example, a shopper in doubt may pick multiple items of different brands, sizes, flavors, and/or types, hoping that one of them is item that is desired by the other shopper(s), and then once the shoppers are united and one of the items are decided upon, the unwanted items may be discarded at an incorrect location in the store.

Furthermore, in some embodiments, each participating shopper's electronic device may be located in the store by monitoring or sensing devices. For example, a well-known radio frequency identification standard and system, such as Radio Frequency Identification (RFID), can be used, where the devices can include tags to be read by stationary readers at locations in the store, or devices can include readers to read the tags at stationary locations in the store, where there is known positioning of the stationary object. Or, signal strength and triangulation can be used to determine the location of a device relative to access points. Other methods and systems may also be used. The location of each electronic device can be transmitted to each other electronic device in the participating shopping activity. This can allow each shopper to quickly locate other parties by using the electronic device, and determine their relative position to other locations or shoppers in the shopping area. For example, the device can display an overhead map of the store layout, with icons or markers indicating where other participating shoppers are currently located in the store.

In step 22, the changes and updates to the individual lists and/or master list provided in step 20 are communicated to the electronic devices of all the participating shoppers via the implemented communication links, unless an update (such as an added entry) is designated as not distributable as explained above, in which case that particular update is not communicated. For example, if an entry was checked off (designated as “obtained”) during step 20, the designated entry and its status (obtained) is communicated to the master list (if maintained at a particular device or computer) and the other electronic devices. The electronic device can send the updates directly to all the other linked devices, or can send the updates to a server which distributes the updates to the other devices. This step may be periodically performed automatically, or can be performed only after an update is made to any of the master or individual lists.

In step 24, the method checks whether any shopper has completed his or her individual list, i.e., whether all the entries of any individual list have been checked off. Alternatively, the process can check in step 24 whether a shopper is nearing completion of his or her individual list, e.g., whether the shopper is within a threshold number of entries to completing the list, or has almost completed a list according to other criteria. The shopper who has completed (or nears completion) of his or her individual list is a “finished shopper.” If no completion has occurred or is near, the process returns to step 20 to continue shopping and update activities.

If one or more individual lists are completed (or nearing completion), then the process continues to step 26, in which it is checked whether there are entries remaining on the master list, corresponding to items yet to be obtained, which warrant a rebalancing of the individual lists. Depending on the embodiment, different criteria can be used to determine the outcome of this step. For example, one method can check whether a sufficient number of entries are left on the master list, e.g., above a predetermined threshold number of entries. Another method can check whether the remaining entries are physically located close enough to the finished shopper, e.g., within a predetermined threshold distance. Another method can check whether the unfinished shopper(s) are located within a small distance (as determined by predetermined threshold distance) to the remaining items. Some or all of these methods can also be combined. The overall purpose is to check whether it is efficient to the shopping activity to rebalance the individual lists and assign the finished shopper additional entries taken from one or more individual lists of unfinished shoppers. The method can also preferably check whether it is efficient to assign any remaining items to unfinished shoppers, e.g., who happen to be located close to remaining items not currently on their individual list. In some embodiments, the shopper(s) have the option to select at any time (via the electronic device) that rebalancing should occur, and can select the criteria governing the rebalancing.

If rebalancing is not warranted or selected in step 26, then the process continues to step 27 to check whether all shoppers are finished. If so, the process ends at 30; if not, the process returns to step 20 to allow the unfinished shoppers to continue their shopping activity until similarly completed. If rebalancing is warranted in step 26, then in step 28 the individual lists are rebalanced so that the finishing shopper's individual list is assigned additional entries from the other shopper's individual lists, and those entries are removed from the individual lists where they had previously been assigned. Rebalancing also can rebalance entries between unfinished shoppers' lists, as explained above.

In one embodiment, the rebalancing can be implemented using the same method and criteria of step 16 to generate the lists. In other embodiments, different methods and criteria from step 16 can be used. Rebalancing the individual lists can be implemented according to different factors and criteria according to different embodiments. In one embodiment, half the remaining entries can be assigned to the finished shopper if there are two shoppers, one-third the remaining entries if there are three shoppers, etc. Additionally (or alternatively), the locations of the shoppers can be checked to determine which entries, and how many entries, should be moved to different individual lists, e.g., if a finished shopper is closer to some items than others, then entries for more of the close-by items can be moved than for the further items. Once the individual lists have been rebalanced, the newly-balanced individual lists are then distributed to all participating shoppers similarly to step 18. The process then returns to step 20 to continue the shopping and related activities and updates.

It should be noted that the above method is an example of one type of embodiment, and that other types of embodiments of the present invention are possible. For example, in an alternate embodiment, no master list is input in step 14, no individual lists are created in step 16, and the participating shoppers use the electronic devices to communicate with each other and/or locate each other in the shopping area to facilitate and coordinate the shopping activity as described in step 20 and complete the activity faster and more efficiently than if the devices were not used. In other embodiments, no master list is input in step 14, and the shoppers create their own individual lists, which are then rebalanced as necessary.

Profiles of preferences can also be used to allow a shopper to decide whether a list is to be used, or not. For example, a user can be presented with a choice between different user profiles, where one user profile allows “ad hoc” shopping without inputting a list of desired items for that shopping trip, while another profile allows the user to enter a shopping list of items. One of the profiles can be set up as a default profile based on user preferences. If the profile without a list is selected, then any other user preferences previously input for that profile can be accessed and used, e.g. typical desired items at particular stores, a preferred order in which to obtain items when shopping, etc. Such user preferences can be entered by the user at any time and relied upon repeatedly.

Some embodiments can allow a non-shopper, i.e. a person not involved in the obtaining of items during the shopping activity, to participate and collaborate in various steps of the present invention, such as participating in creating or changing the master list or individual lists, and/or communicating with the shoppers. For example, a user that is accessing the internet, such as on a personal computer at home, a kiosk in the store or other location, or via some other electronic device, can receive the master list or individual list data and send his or her suggestions and changes to lists stored on (or accessed by) the shoppers' electronic devices (in those embodiments, of course, that allow the electronic devices used in the present invention to access and send data over the internet). The non-shopper can also communicate to shoppers during the shopping activity via the internet or other communication medium or method.

FIG. 2 is a flow diagram illustrating one example of step 16 of FIG. 1, in which multiple individual shopping lists are generated from the master list. Various other methods can be used instead of or in addition to the method described here.

The method starts at 50, and in step 52, categories pertinent to the items described by the entries on the master list are defined. Each item described by the master list can be assigned to a single category. The defined categories can be based on types of items to be shopped for at the store, location of items in the store, the type of store that sells the items (if multiple stores are included in the shopping area), and/or other criteria. For example, one common way to categorize items is by type of items, such as bread, batteries, chair, lamp, soap, etc. Categories can be narrowly defined; for example, for items at a grocery store, categories can include “cereals,” “breads,” “milk,” “cheese,” “yogurt,” “butter,” “lettuce,” “apples,” “eggs,” “frozen dinners,” “frozen vegetables,” “toilet paper,” “paper towels,” “chicken,” “deli meat,” “packaged meat,” etc. Or, categories can be broadly defined, such as “bread and cereal products,” “milk products,” “fruit and vegetable products,” “frozen products,” “paper products,” “meat products,” etc. Another way to categorize would be according to store physical organization, e.g., by store aisles, so that, for example, aisles 1-2 could be one category, aisles 3-4 would be another, etc. Other types of categories can also be defined.

In step 54, the categories are assigned to groups, where the number of groups equals the number of participating shoppers, and where each category is in a single group. This division can be implemented according to one or more of many different possible criteria. For example, a simple division can be performed, where the categories are evenly divided between the groups.

In some embodiments, category division can be enhanced by assigning each category or group a time-cost weight or rating, e.g. based on the number of entries/items included in the category/group or other factors, so that a more equitable division between groups is achieved, allow each shopper's activity to last approximately the same duration. For example, ten items in one category (yogurt) might be the equivalent “weight” of a total of ten items in three other categories (vegetables, fruit, salad dressing). In some embodiments, many items in a single category can be given less weight than a smaller number of items across multiple categories. For example, ten yogurt cup items in one category (“yogurt”) might the equivalent weight to four other items in different categories (e.g., one item in “coffee,” one item in “tea,” and two items in “cereal”). Such weighting thus takes into account the ease of getting items from one category versus a harder task of getting items from other categories.

In some embodiments, the relative location of items in the store can be used to adjust the weighting given to each category or group. For example, if two categories of food in one group are located further apart from each other in the store than two other categories in a different group, then the two categories further apart can be given a larger weight than the closer categories due to more effort being involved to get the items in the further-apart categories. The physical layout of the store (if that information is available) can be taken into account to provide more accurate weighting.

In yet another refinement of weighting categories, individual shopper histories can be taken into account. For example, some shoppers may spend more time in a particular category than another shopper. If this history is known (e.g. from previous shopping trips used with the system of the present invention), then the weighting of categories can be adjusted to compensate for different average shopping times so that equal shopping durations are more closely achieved for the shoppers.

Further, the categories can be divided into groups based on the shortest path between the items in the categories in the physical layout of the store. Thus, for example, if the breads and milk products are located close to each other (e.g., all in one store aisle), and the vegetables and meats are located close to each other but further from items in the other categories, then the bread and milk categories can be put in one group, and the vegetable and meat categories can be put in another group. This makes it easier for each shopper to get the items from one group, since they are located more closely together. Some examples of methods including finding the shortest path between shopping items is described in copending U.S. patent application Ser. No. 10/426,082, entitled, “Method and System for Assisting A Shopper in Navigating Through a Store,” filed Apr. 29, 2003, and incorporated herein by reference in its entirety.

In step 56, the entries on the master list are assigned to the appropriate individual lists based on the groups defined in step 54. The items included in a single group can be assigned to one individual list, i.e., each group can be used to form a different individual list. In some embodiments, new entries can be added to particular individual lists after the groups of step 54 have been formed, where the new items can be subject to the same criteria used in step 54.

In some embodiments, the entries in each individual list can be provided in a particular order to promote efficient shopping if the shopper obtains items in the listed order (or close to the listed order). Thus, the order of entries in the individual list can reflect an efficient route through the store. Furthermore, for example, an individual list can be organized such that the last item in the list is located close to the last item(s) of another participating shopper's individual list. The shoppers would then be able to easily meet up once their items had all been obtained. Furthermore, when one shopper obtains the last item described on that shopper's individual list, the shopper would be located close to items on a different shopper's list within the shopping area, so that if the lists are then rebalanced and the finished shopper is given list entries from the other shopper, the finished shopper can quickly obtain the rebalanced items since they are located close by. In another embodiment, entries for perishable items are placed last on individual lists so that these items are obtained last and have the least amount of time outside of a refrigerated area.

After the individual lists are formed, each individual list is assigned to a particular participating shopper. The process is then complete at 58.

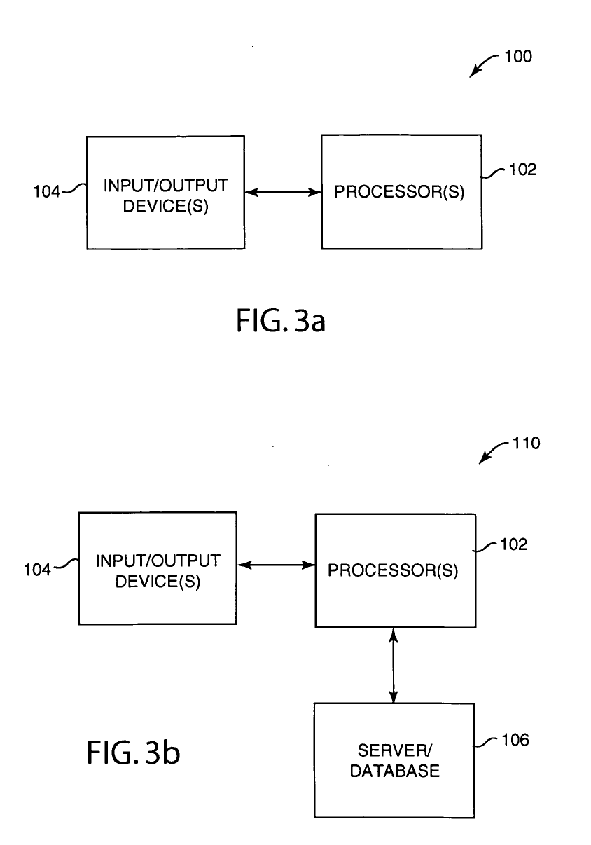

FIG. 3a is a block diagram of an embodiment of a hardware implementation 100 of an electronic device usable by the shoppers (or other users) in accordance with the present invention for assisting shoppers coordinate and collaborate on shopping activity. FIG. 3a depicts device 100 including processor(s) 102 and I/O device(s) 104. Device 100 can be used to implement appropriate steps of method 10. The I/O device(s) 104 are used as an interface with the shopper, and can include devices such as keyboard(s), a touch screen, a display, an IR port for communicating with computer devices such as a PDA, connection with the Internet or other computer network to communicate with shoppers located elsewhere, a scanner, and/or a printing device.

One or more of the shoppers can input the entries that go on the master list to a device 100, and can input any other information or communication via input I/O device(s) 104, such as buttons, keyboard, touchscreen, microphone, voice recognition hardware/software, etc. Such input devices can be used to input the items on the master list, check off entries on master list or individual list as items are obtained, input additional items for an individual list, input messages to be communicated to other shoppers, input options and preferences for displaying lists and communication, input a pathway through the store (e.g., draw a route through the store on a touchscreen that displays an overhead map of the store layout), etc.

Any information in the system or accessible to the system can be output to the user of system 100 via output I/O device(s) 104, such as display screens, touchscreens, audio speakers, printers, motors, etc. Such output information can include the master list, an individual list, other shoppers' individual list(s), any available and/or selected options and preferences, a communication from another shopper (or from some other linked user across a network or communication link, e.g. a message from a cell phone or telephone, email, etc.), a map or other diagram of the store layout, etc. For example, if a layout of the store is desired, such a layout can be an overhead view of the store, including particular locations highlighted or marked to indicate these locations as destinations for the user, and/or the destinations of the other shopper(s).

In some embodiments, an optimal route of the shopper can be displayed for easy reference. In other embodiments, e.g., if a robotic shopping cart is used, the shopper may still receive the route from the I/O device(s) 104. However, because a robotic cart may drive itself to the locations of the items, in an alternate embodiment, the shopper may not receive the route from the I/O device(s) 104. In still another embodiment, the shopper may choose whether or not to receive the route. In an embodiment where one or more retailers markets products to the user of the system 100, the I/O device(s) 104 can be used to provide the shopper with information on substitute and/or additional products in the store.

The processor(s) 102 are preferably used to implement the appropriate steps of method 10. However, one or more of the steps may be performed using another device. Moreover, although the processor(s) 102 are depicted together, one or more of the processor(s) 102 can be located remotely from the remainder of the system 100 and accessed, for example, through the I/O device(s) 104. For example, the system 100 may be coupled to the remote processor(s) (not explicitly shown) via an RF port among the I/O device(s) 104.

The processor(s) 102 can generate the individual lists, govern the communication of entry data to and from the electronic device, facilitate communication between shoppers, determine the locations of the items entered by the user(s) if the items are available, determine an efficient route to obtain the items on an individual list and recalculate the route based upon any additions or deletions to the desired items that the shopper makes, etc. In one embodiment, the processor 102 can also provide the shopper with information relating to substitute and/or additional products based upon the items the shoppers have input. For example, the processor 102 can provide the shopper with discounts, coupons, specials, generic substitutes, or information relating to products sold by the retailer.

Device 100 also preferably includes memory (not shown), such as random access memory (RAM) and read-only memory (ROM), as is well-known to those of skill in the art. This memory can be provided as part of processor 102, separate components, and/or remotely accessed.

In some embodiments, device 100 is a portable, personal electronic device for the shopper, as described above. Some embodiments may have a conventional shopping cart with the electronic device 100 attached. In such an embodiment, the item lists and route can be displayed on a screen. In another embodiment, the device 100 can be part of a robotic cart which automatically drives the shopper to the locations on the route, stops at each location and, upon the proper command being entered by the shopper, drives to the next location. Examples of this embodiment are described in greater detail in copending patent application Ser. No. 10/426,082, previously incorporated by reference.

In some embodiments, the device 100 can also be linked to store locator sensors (not shown). The store locator sensor(s) sense the location of the electronic device (or shopping cart) within the store. Consequently, the processor(s) 102 can determine whether the device has strayed from an optimal route and can recalculate the desired route and reorder the individual list of items. Or, the processor 102 can redirect a shopper to the original route.

In one embodiment, a kiosk or other stationary terminal or access point in the store can be used in the collaboration of shoppers of the present invention. For example, if tracking sensors are used in the store so that the kiosk knows the locations of the shoppers, one shopper who has finished shopping can access a kiosk to determine where the other shopper is and deduce how far that shopper has progressed. Or, a non-shopper (not associated with the store) can access a kiosk to track shopper locations (and participate in the shopping activity, as described above). In some embodiments, non-shoppers such as store personnel or others associated with the store (or law enforcement, etc.) can track individuals to support loss prevention/theft prevention activities; these individuals are typically not given access to change the lists of the shoppers, but in some embodiments can use the communication capabilities of the present invention to notify shoppers of events or other information (shoppers can also be provided the ability to send information via the electronic device to one or more devices accessed by store personnel, e.g., questions about inventory or the location of desired items, current status of items, problems such as spills or messes, etc.) Thus, different users with access to the shopping collaboration system can be given any of various levels of access rights, where the rights include the ability to edit master/individual lists, communicate with shoppers, and track the locations of shoppers.

Using the device 100 and the method 10, a shopper may be better able to find the items on an individual list. The route used by the shopper may be the shortest, most efficient route. In addition, the shopper is allowed to edit the items on his or her individual list. The items and route to the items can thus respond to shoppers changing desires. For example, the shopper might remember an item omitted, might decide not to purchase certain items, or might respond to marketing in the store by desiring to purchase additional and/or different items. The master list, individual lists, and route through the store can then be updated to ensure that the remainder of the items are balanced efficiently between the shoppers and can be found in the most efficient manner. Furthermore, because the shopper inputs the items desired, the retailer may be better able to individually tailor marketing of products to each shopper while the shopper is in the store.

FIG. 3b depicts another embodiment of a device 110 in accordance with the present invention. The major components of the device 110 have analogous structure and/or function as the device 100 described above, and are therefore labeled similarly. Thus, the device 110 includes processor(s) 102 and I/O device(s) 104. In addition, the device 100 communicates with a server or database 106. The database 106 may or may not reside in a location remote from the processor(s) 102 and I/O device(s) 104. In some embodiments, the server/database 106 can store the master list and can update the master list when data is communicated to the server 106 from one or more devices 110.

The database 106 can also store information about the items carried by the store or retailer. For example, the database 106 might include the identity of products such as a bar code, the location of the items, the price of the items, the availability of the items and substitutes for the items. Thus, the processor(s) 102 might use the database 106 to determine the locations of the items entered, whether items entered by the shopper are available, substitutes for the items entered by the shopper, discounts, or other information used to assist the shopper.

Although the present invention has been described herein as pertinent to shoppers and shopping activity, the present invention is also applicable to other activities and environments. For example, in a warehouse, shipping area of a company, or other storage facility, there can be a large number and variety of items stored. Particular items may have to be located and counted, indexed, retrieved, moved, or otherwise manipulated. The present invention can make inventory or similar activities quicker and easier by allowing two or more people to perform the activities and collaborate during the activity using lists and/or communication as described in detail above.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for coordinating the activity of a plurality of participating users, the method comprising:
(a) organizing a plurality of individual lists, each individual list associated with a different participating user and including a plurality of entries, each entry describing an item to be obtained or located by the associated user during the activity; and
(b) providing each individual list to a different one of a plurality of electronic devices, each electronic device accessible to a different one of the participating users, wherein each participating user can access the associated individual list and obtain or locate the items described on that user's individual list during the activity.

2. The method of claim I wherein the activity is a shopping activity to obtain items in one or more shopping areas, and the participating users are participating shoppers.

3. The method of claim 2 wherein the entries are assigned to the individual lists so as to achieve an approximately equal shopping time for each participating shopper.

4. The method of claim 3 wherein each individual list is generated from a master list that includes entries describing all the items desired to be obtained, wherein the entries of the master list are divided between the individual lists.

5. The method of claim 4 further comprising facilitating communication between participating shoppers via the electronic devices during the shopping activity.

6. The method of claim 4 wherein, during the shopping activity, a shopper can designate an entry on that shopper's individual list to indicate that the associated item has been or is being obtained, wherein the designated entry and its designated status are communicated to the other electronic devices of the other shoppers.

7. The method of claim 6 wherein, during the shopping activity, if one shopper obtains items faster than at least one other shopper, the individual lists are rebalanced to move entries from at least one individual list to at least one other individual list to approximately equalize shopping time between all participating shoppers.

8. The method of claim 7 wherein the rebalancing of the individual lists occurs after a shopper has designated all items on that shopper's individual list as obtained.

9. The method of claim 8 wherein each individual list includes entries that are provided in a particular order such that when a shopper obtains the last item described on that shopper's individual list, the shopper is located close to items on a different shopper's list within a shopping area, thereby promoting efficient rebalancing of the individual lists.

10. The method of claim 4 wherein a shopper can view the master list from that shopper's electronic device.

11. The method of claim 10 wherein a shopper can designate an entry on the master list to indicate that the item associated with the marked entry has been obtained, wherein the designated entry is communicated to the other electronic devices of the other shoppers and is designated as having been obtained on the individual list including the same entry as the marked entry.

12. The method of claim 4 wherein a shopper may add an entry to that shopper's individual list, wherein the added entry is communicated and visible to at least one other electronic device of a participating shopper.

13. The method of claim 12 wherein the added entry is not communicated and not visible to the other electronic devices of the other participating shoppers.

14. The method of claim 5 wherein the facilitation of communication between shoppers includes allowing a shopper to input a message to that shopper's electronic device and transmitting the message to one or more electronic devices of the other shoppers.

15. The method of claim 4 wherein the individual lists are generated by dividing the items into categories and dividing the categories between individual lists.

16. The method of claim 4 wherein the items on the master list are weighted so as to evenly divide the shopping time between shoppers when some of the items may take longer to obtain than other items.

17. The method of claim 2 wherein a shopping history of one or more of the participating shoppers is taken into account so as to evenly divide the shopping time between shoppers when organizing the individual lists.

18. The method of claim 4 wherein generating the individual lists includes putting entries for items that are physically located close together on the same individual list.

19. The method of claim 4 further comprising sensing the location of the participating shoppers using a sensor system and providing each electronic device with information allowing each participating shopper to monitor the locations of at least one other shopper in a shopping area.

20. The method of claim 2 wherein the individual lists can be edited by the participating shoppers, and can also be edited by one or more non-shoppers.

21. The method of claim 20 wherein at least one of the one or more non-shoppers can access the electronic devices of the participating shoppers via the internet.

22. A method for coordinating the activity of a plurality of participating users, the method comprising:
(a) receiving an individual list on an electronic device accessible by a participating user, the individual list including at least one entry, each entry describing an associated item to be obtained or located by the participating user during the activity; and
(b) sending out updates and changes to the individual list during the activity over a communication link, wherein at least one other electronic device accessible to another one of the participating users can receive the sent updates and changes.

23. The method of claim 22 wherein the activity is a shopping activity to obtain items in one or more shopping areas, and the participating users are participating shoppers.

24. The method of claim 23 further comprising receiving changes to the individual list from the shopper via input to the electronic device.

25. The method of claim 24 wherein the updates and changes include designating an entry of the individual list to indicate that the item associated with the entry has been or is being obtained.

26. The method of claim 24 wherein the individual list has been generated from a master list that includes entries describing all the items desired to be obtained by the participating shoppers, and further comprising receiving the master list and sending out updates or changes to the master list made by the shopper via input to the electronic device.

27. The method of claim 23 wherein, during the shopping activity, if participating shopper obtains items faster than at least one other participating shopper, the individual list is rebalanced to move entries from at least one other individual list to the individual list to help equalize shopping time between all participating shoppers.

28. The method of claim 23 further comprising communicating messages between the electronic device and other electronic devices to allow communication between the participating shoppers during the shopping activity.

29. A method for coordinating the shopping activity of a plurality of participating shoppers, the method comprising:
(a) providing a plurality of portable electronic devices, each electronic device accessible to a different one of the participating shoppers; and
(b) facilitating the shopping activity of the participating shoppers in a shopping area via the electronic devices by allowing communication between participating shoppers and allowing each shopper to locate at least one other shopper in the shopping area during the shopping activity.

30. The method of claim 29 wherein the communication between shoppers includes one shopper inputting a message to that shopper's electronic device and transmitting the message to one or more electronic devices of the other shoppers.

31. The method of claim 30 wherein the message to one or more other shoppers is input by the shopper in text form.

32. The method of claim 30 wherein the message to one or more other shoppers is input by the shopper in voice form.

33. The method of claim 29 further comprising sensing the location of the participating shoppers using a sensor system and providing each electronic device with information allowing each participating shopper to monitor the locations of at least one other shopper in a shopping area.

34. The method of claim 29 further comprising:
generating a plurality of individual lists, each individual list associated with a different participating shopper and including entries describing items to be obtained by the associated shopper while shopping; and
providing each individual list to a different one of a plurality of electronic devices, each electronic device accessible to a different one of the participating shoppers, wherein each participating shopper can view the associated individual list in order to obtain the items described on that shopper's individual list during the shopping activity.

35. The method of claim 34 wherein each individual list is generated from a master list that includes entries describing all the items desired to be obtained, wherein the entries of the master list are divided between the individual lists so as to achieve an approximately equal shopping time for each participating shopper.

36. The method of claim 34 wherein, during the shopping activity, a shopper can designate an entry on that shopper's individual list to indicate that the associated item has been or is being obtained, wherein the designated entry is communicated to the other electronic devices of the other shoppers.

37. The method of claim 30 further comprising allowing communication between at least one of the participating shoppers and one or more non-shoppers.

38. The method of claim 37 wherein at least one of the one or more non-shoppers can communicate with the electronic devices of the participating shoppers via the internet.

39. A computer readable medium including program instructions to be implemented by a computer, the program instructions for coordinating the activity of a plurality of participating users, and implementing steps comprising:
(a) generating a plurality of individual lists, each individual list associated with a different participating user and including entries describing items to be obtained or located by the associated user during the activity; and
(b) providing each individual list to a different one of a plurality of electronic devices, each electronic device accessible to a different one of the participating users, wherein each participating user can access the associated individual list in order to obtain or locate the items described on that user's individual list during the activity.

40. The computer readable medium of claim 39 wherein the activity is a shopping activity to obtain items in one or more shopping areas, and the participating users are participating shoppers.

41. The computer readable medium of claim 40 wherein the entries are assigned to the individual lists so as to achieve an approximately equal shopping time for each participating shopper.

42. The computer readable medium of claim 41 wherein each individual list is generated from a master list that includes entries describing all the items desired to be obtained, wherein the entries of the master list are divided between the individual lists.

43. The computer readable medium of claim 42 further comprising facilitating communication between participating shoppers via the electronic devices during the shopping activity.

44. The computer readable medium of claim 42 wherein, during the shopping activity, a shopper can designate an entry on that shopper's individual list to indicate that the associated item has been or is being obtained, wherein the designated entry and its designated status are communicated to the other electronic devices of the other shoppers.

45. The computer readable medium of claim 44 wherein, during the shopping activity, if one shopper obtains items faster than at least one other shopper, the individual lists are rebalanced to move entries from at least one individual list to at least one other individual list to approximately equalize shopping time between all participating shoppers.

46. The computer readable medium of claim 44 wherein a shopper can designate an entry on the master list to indicate that the item associated with the designated entry has been obtained, wherein the designated entry is communicated to the other electronic devices of the other shoppers and is marked as having been obtained on the individual list including the same entry as the designated entry.

47. The computer readable medium of claim 42 wherein a shopper may add an entry to that shopper's individual list, wherein the added entry is communicated and visible to at least one other electronic device of a participating shopper.

48. The computer readable medium of claim 43 wherein the facilitation of communication between shoppers includes allowing a shopper to input a message to that shopper's electronic device and transmitting the message to one or more electronic devices of the other shoppers.

49. The computer readable medium of claim 42 wherein the individual lists are generated by dividing the items into categories and dividing the categories between individual lists, wherein the categories of items are weighted so as to evenly divide the shopping time between shoppers when different numbers of items are in different categories.

50. The computer readable medium of claim 42 wherein generating the individual lists includes putting entries for items that are physically located close together on the same individual list.

51. A system for coordinating the activity of a plurality of participating users, the system comprising:
(a) means for generating a plurality of individual lists, each individual list associated with a different participating user and including entries describing items to be obtained by the associated user during the activity; and
(b) means for providing each individual list to a different one of a plurality of electronic devices, each electronic device accessible to a different one of the participating users, wherein each participating user can access the associated individual list in order to obtain the items described on that user's individual list during the activity.

52. The system of claim 51 wherein the activity is a shopping activity to obtain items in one or more shopping areas, and the participating users are participating shoppers.

53. The system of claim 52 wherein the entries are assigned to the individual lists so as to achieve an approximately equal shopping time for each participating shopper.

54. The system of claim 53 wherein each individual list is generated from a master list that includes entries describing all the items desired to be obtained, wherein the entries of the master list are divided between the individual lists.

55. The system of claim 54 further comprising means for facilitating communication between participating shoppers via the electronic devices during the shopping activity.

56. The system of claim 54 wherein, during the shopping activity, a shopper can designate an entry on that shopper's individual list to indicate that the associated item has been or is being obtained, wherein the designated entry and its designated status are communicated to the other electronic devices of the other shoppers.

57. The system of claim 56 wherein, during the shopping activity, if one shopper obtains items faster than at least one other shopper, the individual lists are rebalanced to move entries from at least one individual list to at least one other individual list to approximately equalize shopping time between all participating shoppers.

58. The system of claim 56 further comprising means for communicating that an entry has been designated by a shopper on the master list to indicate that the item associated with the designated entry has been obtained, wherein the designated entry is communicated to the other electronic devices of the other shoppers and is also designated as having been obtained on the individual list including the same entry as the designated entry.

59. The system of claim 54 further comprising communicating an entry that has been added to an individual list to at least one other electronic device of a participating shopper.

60. The computer readable medium of claim 55 wherein the means for facilitation of communication between shoppers includes means for allowing a shopper to input a message to that shopper's electronic device and means for transmitting the message to one or more electronic devices of the other shoppers.

61. The system of claim 54 wherein the individual lists are generated by dividing the items into categories and dividing the categories between individual lists, wherein the categories of items are weighted so as to evenly divide the shopping time between shoppers when different numbers of items are in different categories.

62. The system of claim 54 further comprising means for sensing the location of the participating shoppers using a sensor system and means for providing each electronic device with information allowing each participating shopper to monitor the locations of at least one other shopper in a shopping area.

63. A computer readable medium including program instructions to be implemented by a computer, the program instructions for coordinating the activity of a plurality of participating users, and implementing steps comprising:
(a) receiving an individual list on an electronic device accessible by a participating user, the individual list including at least one entry, each entry describing an associated item to be obtained or located by the participating user during the activity; and
(b) sending out updates and changes to the individual list during the activity over a communication link, wherein at least one other electronic device accessible to another one of the participating users can receive the sent updates and changes.

64. A system for coordinating the activity of a plurality of participating users, the system comprising:
(a) means for receiving an individual list on an electronic device accessible by a participating user, the individual list including at least one entry, each entry describing an associated item to be obtained or located by the participating user during the activity; and
(b) means for sending out updates and changes to the individual list during the activity over a communication link, wherein at least one other electronic device accessible to another one of the participating users can receive the sent updates and changes.
